(19) United States
(12) Patent Application Publication
(10) Pub. No.: US 2017/0228764 A1
(43) Pub. Date: Aug. 10, 2017

(54) Reducing Bias Caused by Cleared Cookies

(71) Applicant: Google Inc., Mountain View, CA (US)

(72) Inventors: Cameron M. Tangney, Seattle, WA (US); Sissie Ling-Ie Hsiao, Los Altos, CA (US); Chao Cai, Santa Clara, CA (US)

(21) Appl. No.: 15/425,252

(22) Filed: Feb. 6, 2017

Related U.S. Application Data
(63) Continuation of application No. 13/069,800, filed on Mar. 23, 2011, now abandoned.
(60) Provisional application No. 61/316,687, filed on Mar. 23, 2010.

(51) Int. Cl. G06Q 30/02; H04L 12/26; H04L 29/08

(52) U.S. Cl. CPC G06Q 30/0244; H04L 67/146; H04L 43/045; H04L 67/02; G06Q 30/0243; G06Q 30/0277; G06F 3/04847

(57) ABSTRACT

Methods, systems, and apparatus, including computer programs encoded on a computer storage medium for reducing bias caused by cleared cookies. In one aspect, a method includes obtaining, from a historical data store storing data obtained from cookies that have been placed on various client devices, a set of the data obtained from the cookies. The contents of a given cookie are used to identify an initialization time when the given cookie was placed on a given client device by a server. A determination is made, based on the initialization time, that the cookie has an age that is less than the threshold age. Data obtained from the given cookie is filtered from inclusion in a final set of data that is used to generate measurements based on the age of the cookie being less than the threshold age.

### BACKGROUND

This specification relates to determining content performance measures and providing performance reports.

The Internet provides access to a wide variety of resources. For example, video and/or audio files, as well as web pages for particular subjects or particular news articles are accessible over the Internet. Access to these resources presents opportunities for advertisements to be provided with the resources. For example, a web page can include advertisement slots in which advertisements can be presented. These advertisements slots can be defined in the web page or defined for presentation with a web page, for example, in a pop-up window.

Advertisement slots can be allocated to advertisers through an auction. For example, advertisers can provide bids specifying amounts that the advertisers are respectively willing to pay for presentation of their advertisements. In turn, an auction can be performed and the advertisement slots can be allocated to advertisers according to their bids. When one advertisement slot is being allocated in the auction, the advertisement slot can be allocated to the advertiser that provided the highest bid or a highest auction score (e.g., a score that is computed as a function of a bid and/or an advertisement quality measure). When multiple advertisement slots are allocated in a single auction, the advertisement slots can be allocated to a set of bidders that provided the highest bids or have the highest auction scores.

Advertisement management accounts can enable advertisers to specify keywords and corresponding bids that are used to control allocation of their advertisements. The advertiser can also track the performance of advertisements that are provided using the keywords and corresponding bids. For example, an advertiser can access the advertisement management account and view performance measures corresponding to the advertiser's advertisements that were distributed using each keyword. In turn, the advertiser can adjust settings that control the allocation of advertisements and compare the performance measures for the advertisements that are allocated using the new settings.

### SUMMARY

Content providers (e.g., advertisers) are provided user interaction reports that measure user interactions with content that is distributed to users for the content providers. In some implementations, the reports that are provided to a particular content provider specify performance measures measuring user interactions with content that occur prior to a conversion.

The data that are used to generate the performance measures for the advertiser generally include all data that are available. While using a large data set can be useful for providing statistically relevant performance measures, incomplete data sets can skew the performance measures. For example, if a performance measure depends on a series of data points that represent a user's actions over a specified period of time, this series of data points may be gathered by identifying data points that are associated with a cookie for the user. However, if the user's cookies were cleared in the middle of the period of time, then the data associated with the cookie may inaccurately represent the user's actions. Thus, performance measures computed using the series of data points for this user may be skewed.

To reduce the likelihood that performance measures may be skewed due to data that inaccurately represent users' actions, content providers can be provided with the capability of specifying a reporting period (i.e., a lookback window) that specifies a period within which user interactions must have occurred in order to be used for computing performance measures. Specification of a reporting period reduces the likelihood that older user actions, which may not be particularly relevant to a recent conversion, will skew the performance measures.

Content providers can also be provided the capability to exclude potentially incomplete conversion cycles by specifying that only user interaction data that are associated with (i.e., indexed according to, stored in a same cookie with, and/or stored with a reference to) user identifiers that are at least a minimum specified age (e.g., were created and/or placed on a user device prior to a specified time period.) Specification of a minimum specified age reduces the likelihood that the user interaction data used to compute the performance measures represent only a tail end or an incomplete history of actual user interaction data for a conversion cycle.

In general, one innovative aspect of the subject matter described in this specification can be embodied in methods in which a request is received for a user interaction report that specifies measures of user interactions with content items for a reporting period. Initial user interaction data representing user interactions with content items over the reporting period are obtained, where the user interaction data is associated with unique identifiers that each represents a user device with which user interactions are associated. For each of the unique identifiers an initialization time that specifies a time at which the unique identifier was associated with a user device is determined. In turn, initial user interaction data that are associated with unique identifiers having at least a minimum age are selected as final user interaction data, where the age of a unique identifier is an amount of time between the initialization time for the unique identifier and a time at which the conversion occurred. The user interaction report is generated using the final user interaction data. Other embodiments of this aspect include corresponding systems, apparatus, and computer programs, configured to perform the actions of the methods, encoded on computer storage devices.

These and other embodiments can each optionally include one or more of the following features. User interaction data can be obtained by obtaining user interaction data that are associated with cookies that represent user devices with which the user interactions were performed. User interaction data that are associated with a cookie can be obtained by obtaining user interaction data that are associated with cookies that have initialization times that are specified by the cookies, where an initialization time being a time at which a cookie was initially set at a user device.

Final user interaction data can be selected by selecting, as final user interaction data, the initial user interaction data that are associated with cookies that specify initialization times that are prior to the beginning of the reporting period.

A request for a user interaction report can be received by receiving a request for a conversion path report that specifies measures of user interactions over conversion paths, wherein a conversion path is a set of user interactions with one or more content items and an action that constitutes a conversion, the user interactions being one or more presentations of the content items to the user and zero or more selections of the content items by the user.

Final user interaction data can be selected by determining, for each conversion in the initial user interaction data, a cookie age that represents an amount of time between a time at which the conversion occurred and an initialization time for a cookie that is associated with the conversion; and selecting, as final user interaction data, the initial user interaction data for conversions that are associated with cookies having cookie ages that exceed a minimum cookie age for the user interaction report.

The user interaction report can be generated by generating the conversion path report that specifies measures of user interactions over the conversion path. Each cookie can represent a unique pair of components including a user device and browser.

Methods can provide data that cause presentation of a user interface that includes a minimum identifier age filter control that enables an advertiser to selectively specify that measures of user interactions be computed using user interaction data that are associated with user identifiers having ages that are at least a minimum age.

Methods can provide data that cause presentation of a user interface that includes a first user interaction report using the final user interaction data and further cause presentation of another user interaction report using the initial user interaction data.

In general, another aspect of the subject matter described in this specification can be embodied in methods in which, for each of a plurality of user conversions, user interaction data specifying user interactions with content items over an initial lookback window are obtained, where the initial lookback window for each user conversion is a period preceding the user conversion, and where a user conversion is a specified user action that satisfies a conversion condition. Measures of user interactions are computed for each conversion using the user interaction data, where the measures of user interactions measure interactions by a particular user with content items over the initial lookback window, and where the particular user is a user that is associated with the conversion. It is determined that one or more additional lookback windows are selectively available for reporting measures of user interactions for the conversions, where each of the additional lookback windows is a period preceding each user conversion that is shorter than the initial lookback window for the conversion. Measures of user interactions are computed for each conversion and using the user interaction data, where the measures of user interactions for each conversion are for interactions by a particular user with content items over each of the additional lookback windows. A request is received for a user interaction report that specifies measures of user interactions with content items over at least one of the initial lookback window and the additional lookback windows. Data that cause presentation of the requested user interaction report are provided. Other embodiments of this aspect include corresponding systems, apparatus, and computer programs, configured to perform the actions of the methods, encoded on computer storage devices.

These and other embodiments can each optionally include one or more of the following features. User interaction data can be stored for each conversion, where the user interaction data for each conversion represents user interactions by a particular user that occurred within the initial lookback window.

Data can be provided that cause presentation of a user interface that includes a report request element that upon selection causes submission of the request for the user interaction report, the report request element including a report period element that enables an advertiser to specify a lookback window for the user interaction report.

The measures of user interactions with content items over the initial lookback window can be computed by computing, for each conversion, an average quantity of user interactions that are associated with a same user identifier as the conversion. A number of user interactions can be computed by computing a number of user selections of content items that are associated with the same user identifier as the conversion. A number of user interactions can be computed by computing a number of impressions that are associated with the same user identifier as the conversion. Measures of user interactions with content items over each of the additional lookback windows can be computed by computing, for each conversion, a number of clicks and a number of impressions for content items presented during the initial lookback window preceding the conversion.

Methods can further provide data that cause presentation of a user interaction report that specifies measures of user interaction for one or more conversions, where the specified measures of user interaction are computed using user interaction data for user interactions that are associated with a timestamp that is within the initial report period.

Methods can further provide data that cause presentation of a user interaction report that specifies measures of user interaction for one or more conversions over two or more lookback windows, where the specified measures of user interaction are computed using user interactions data for user interactions that are associated with a timestamp that is within any of the two or more lookback windows. Data that cause presentation of a user interaction report that specifies measures of user interaction for one or more conversions over two or more lookback windows can be provided by providing data that causes presentation of the specified measures of user interaction for a first lookback window at a first presentation location that is adjacent to a second presentation location at which the specified measures of user interaction for a second lookback window.

Particular embodiments of the subject matter described in this specification can be implemented so as to realize one or more of the following advantages. Content performance measures can represent a full set of user interactions that led to a specified user interaction by adjusting a lookback window with which user interaction data is selected for generating the content performance measures. More robust content performance measures can be generated using user interaction data that has been filtered to remove user interaction data that is associated with a user identifier that is less than a threshold age.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a content management system manages advertising services.

FIG. 2 is a flow chart of an example process for presenting a user interaction report.

FIG. 3 is a flow chart of an example process for generating a user interaction report.

FIG. 4 is a screen shot of an example user interface for providing a user interaction report.

FIG. 5 is a block diagram of an example computer system that can be used to provide user interaction reports.

Like reference numbers and designations in the various drawings indicate like elements.

### DETAILED DESCRIPTION

Content providers (e.g., advertisers) are provided user interaction reports that measure user interactions with content that is distributed to users for the content providers. In some implementations, the reports that are provided to a particular content provider specify performance measures measuring user interactions with content that occur prior to a conversion.

As used throughout this document, user interactions are any presentation of content to a user and any subsequent affirmative actions or non-actions (collectively referred to as “actions” unless otherwise specified) that a user takes in response to presentation of content to the user (e.g., selections of the content following presentation of the content, or no selections of the content following the presentation of the content). Thus, a user interaction does not necessarily require a selection of the content (or any other affirmative action) by the user.

Configuration options can be offered to reduce bias in performance reports that can occur due to reports being based on a subset of user interaction data associated with a conversion. Configuration options include allowing an advertiser to specify a variable reporting period (i.e., a lookback window) that can be, for example, matched to or based on a typical conversion cycle length for the advertiser. Configuration options also include enabling an advertiser to exclude user interaction data from a report if unique identifiers associated with the user interaction data are not at least a minimum specified age because the user interaction data that are associated with these unique identifiers may only represent a tail end or an incomplete history of actual user interaction data for a conversion cycle. For example, a unique identifier may have an initialization time that is more recent than the beginning of a specified period prior to a conversion, indicating that the unique identifier has been recently associated with a particular user device. For example, a user may have deleted cookies on the user device after the beginning of the specified period for the particular conversion.

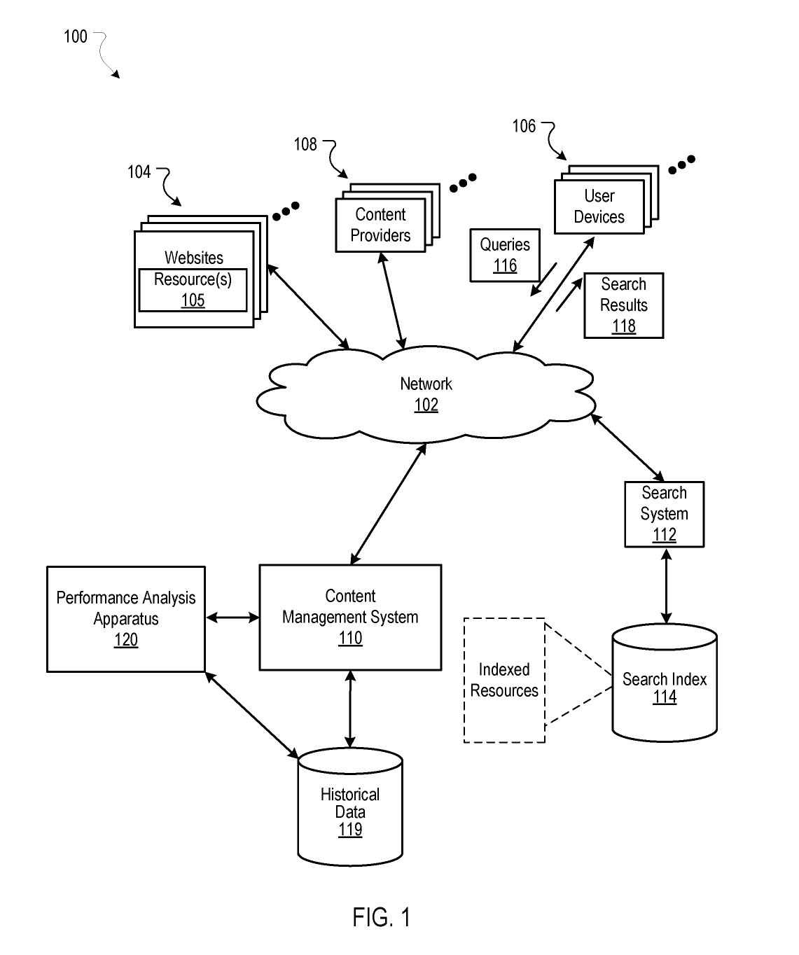

FIG. 1 is a block diagram of an example environment 100 in which a content management system 110 manages advertising services. The example environment 100 includes a network 102, such as a local area network (LAN), a wide area network (WAN), the Internet, or a combination thereof. The network 102 connects websites 104, user devices 106, advertisers 108, and the content management system 110. The example environment 100 may include many thousands of websites 104, user devices 106, and advertisers 108.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as JavaScript scripts).

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can include data specifying a portion of the resource or a portion of a user display (e.g., a presentation location of a pop-up window or in a slot of a web page) in which advertisements can be presented. These specified portions of the resource or user display are referred to as advertisement slots.

To facilitate searching of these resources, the environment 100 can include a search system 112 that identifies the resources by crawling and indexing the resources provided by the publishers on the websites 104. Data about the resources can be indexed based on the resource with which the data is associated. The indexed and, optionally, cached copies of the resources are stored in a search index 114.

User devices 106 can submit search queries 116 to the search system 112 over the network 102. In response, the search system 112 accesses the search index 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. An example search result 118 can include a web page title, a snippet of text or a portion of an image extracted from the web page, and the uniform resource locator (“URL”) of the web page. Search results pages can also include one or more advertisement slots in which advertisements can be presented.

A search result page can be sent with a request from the search system 112 for the web browser of the user device 106 to set a Hypertext Transfer Protocol (HTTP) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie, contain lines requesting the browser to store a cookie for the site hosted by the server. If the browser supports cookies and cookies are enabled, every subsequent page request to the same server will include the cookie for that server. The cookie can store a variety of data, including a unique or semi-unique identifier. The identifier can be anonymized so that the privacy of users is protected. For example, the semi-unique identifiers can be associated with users, but the actual identifying information of the users is not stored in the cookie. Additionally, any identified user interactions can be generalized (for example, generalized based on user demographics) rather than associated with a particular user. Encryption and obfuscation techniques can also be used to protect the privacy of users. Because HTTP is a stateless protocol, the use of cookies allows an external service, such as the search system 112 or other system, to track particular actions and status of a user over multiple sessions.

When a resource 105 or search results 118 are requested by a user device 106, the content management system 110 receives a request for advertisements to be provided with the resource 105 or search results 118. The request for advertisements can include characteristics of the advertisement slots that are defined for the requested resource or search results page, and can be provided to the content management system 110. For example, a reference (e.g., URL) to the resource for which the advertisement slot is defined, a size of the advertisement slot, and/or media types that are available for presentation in the advertisement slot can be provided to the content management system 110. Similarly, keywords (i.e., one or more words that are associated with content) associated with a requested resource (“resource keywords”) or a search query 116 for which search results are requested can also be provided to the content management system 110 to facilitate identification of advertisements that are relevant to the resource or search query 116.

Based on data included in the request for advertisements, the content management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries 116. In some implementations, advertisements having targeting keywords that match the resource keywords or the search query 116 are selected as eligible advertisements by the content management system 110.

The content management system 110 selects an eligible advertisement for each advertisement slot of a resource 105 or of a search results page. The resource 105 or search results page is received by the user device 106 for presentation by the user device 106. User interaction data representing user interactions with presented advertisements can be stored in an advertising data store 119. For example, when an advertisement is presented to the user, data can be stored in the advertisement data store 119 representing the advertisement impression. In some implementations, the data is stored in response to a request for the advertisement that is presented. For example, the ad request can include data identifying a particular cookie, such that data identifying the cookie can be stored in association with data that identifies the advertisement(s) that were presented in response to the request.

Similarly, when a user selects (i.e., clicks) a presented advertisement, data can be stored in the advertisement data store 119 representing the selection of the advertisement. In some implementations, the data is stored in response to a request for a web page that is linked to by the advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers that each represents a corresponding user device with which the user interactions were performed. For example, in some implementations, user interaction data can be associated with one or more cookies. Each cookie can include content which specifies an initialization time that indicates a time at which the cookie was initially set on the particular user device 106.

The advertising data store 119 also stores references to advertisements and data representing conditions under which each advertisement was selected for presentation to a user. For example, the advertising data store 119 can store targeting keywords, bids, and other criteria with which eligible advertisements are selected for presentation. Additionally, the advertising data store 119 can include data that specifies a number of impressions that each advertisement has received, and the number of impressions for each advertisement can be delineated, for example, using the keywords that caused the advertisement to receive impressions and/or the cookies that are associated with the impressions. Data for each impression can also be stored so that each impression and user selection can be associated with (i.e., stored with references to and/or indexed according to) the advertisement that was selected and/or the targeting keyword that caused the advertisement to be selected for presentation.

The advertisers 108 can submit, to the content management system 110, campaign parameters (e.g., targeting keywords and corresponding bids) that are used to control distribution of advertisements. The advertisers 108 can access the content management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements. The campaign performance report can also provide a total cost, a cost-per-click, and other cost measures for the advertisement over a specified period of time. For example, an advertiser may access a performance report that specifies that advertisements distributed using the phrase match keyword “hockey” have received 1,000 impressions (i.e., have been presented 1,000 times), have been selected (e.g., clicked) 20 times, and have been credited with 5 conversions. Thus, the phrase match keyword hockey can be attributed with 1,000 impressions, 20 clicks, and 5 conversions.

As described above, reports that are provided to a particular content provider can specify performance measures measuring user interactions with content that occur prior to a conversion. A conversion occurs when a user performs a specified action, and a conversion path includes a conversion and a set of user interactions by a user prior to a conversion by the user. What constitutes a conversion may vary from case to case and can be determined in a variety of ways. For example, a conversion may occur when a user clicks on an advertisement, is referred to a web page, and then consummates a purchase before leaving that web page.

Actions that constitute a conversion can be specified by each advertiser on an advertiser by advertiser basis. For example, each advertiser can select, as a conversion, one or more measurable/observable user actions such as, for example, downloading a white paper, navigating to at least a given depth of a website, viewing at least a certain number of web pages, spending at least a predetermined amount of time on a website or web page, or registering on a website. Other actions that constitute a conversion can also be used. As used throughout this document, a conversion occurs upon the occurrence of the final action that is used to define a conversion. For example, if a user visiting 5 web pages defines a conversion, the conversion occurs upon the user's request for the 5th web page, and the 4 page views that occurred prior to the request for the 5th web page are considered to have occurred prior to the conversion.

To track conversions (and other interactions with an advertiser's website), an advertiser can include, in the advertiser's web pages, a portion of code that monitors user interactions (e.g., page selections, content item selections, and other interactions) with advertiser's website, and can detect a user interaction (or series of user interactions) that constitutes a conversion. In some implementations, when a user accesses a web page, or another resource, from a referring web page (or other resource), the referring web page (or other resource) for that interaction can be identified, for example, by execution of a snippet of code that is associated with the web page that is being accessed and/or based on a URL that is used to access the web page.

For example, a user can access an advertiser's website by selecting a link presented on a web page, for example, as part of a promotional offer by an affiliate of the advertiser. This link can be associated with a URL that includes data (i.e., text) that uniquely identifies the resource from which the use is navigating. For example, the link http://www.example.com/homepage/%affiliate_identifier%promotion_1 specifies that the user navigated to the example.com web page from a web page of the affiliate that is associated with the affiliate identifier number that is specified in the URL, and that the user was directed to the example.com web page based on a selection of the link that is included in the promotional offer that is associated with promotion 1. The user interaction data for this interaction (i.e., the selection of the link) can be stored in a database and used, as described below, to facilitate performance reporting.

When a conversion is detected for an advertiser, conversion data representing the conversion can be transmitted to a data processing apparatus (“analytics apparatus”) that receives the conversion data, and in turn, stores the conversion data in a data store. This conversion data can be stored in association with one or more cookies for the user device that was used to perform the user interaction, such that user interaction data associated with the cookies can be associated with the conversion and used to generate a performance report for the conversion.

Typically, a conversion is attributed to a targeting keyword when an advertisement that is targeted using the targeted keyword is the last clicked advertisement prior to the conversion. For example, advertiser X may associate the keywords “tennis,” “shoes,” and “Brand-X” with advertisements. In this example, assume that a user submits a first search query for “tennis,” the user is presented a search result page that includes advertiser X's advertisement, and the user selects the advertisement, but the user does not take an action that constitutes a conversion. Assume further that the user subsequently submits a second search query for “Brand-X,” is presented with the advertiser X's advertisement, the user selects advertiser X's advertisement, and the user takes action that constitutes a conversion (e.g., the user purchases Brand-X tennis shoes). In this example, the keyword “Brand-X” will be credited with the conversion because the last advertisement selected prior to the conversion (“last selected advertisement”) was an advertisement that was presented in response to the “Brand-X” being matched.

Providing conversion credit to the keyword that caused presentation of the last selected advertisement (“last selection credit”) prior to a conversion is a useful measure of advertisement performance, but this measure alone does not provide advertisers with data that facilitates analysis of a conversion cycle that includes user exposure to, and/or selection of, advertisements prior to the last selected advertisement. For example, last selection credit measures alone do not specify keywords that may have increased brand or product awareness through presentation of advertisements that were presented to, and/or selected by, users prior to selection of the last selected advertisement. However, these advertisements may have contributed significantly to the user subsequently taking action that constituted a conversion.

In the example above, the keyword “tennis” is not provided any credit for the conversion, even though the advertisement that was presented in response to a search query matching the keyword “tennis” may have contributed to the user taking an action that constituted a conversion (e.g., making a purchase of Brand-X tennis shoes). For instance, upon user selection of the advertisement that was presented in response to the keyword “tennis” being matched, the user may have viewed Brand-X tennis shoes that were available from advertiser X. Based on the user's exposure to the Brand-X tennis shoes, the user may have subsequently submitted the search query “Brand-X” to find the tennis shoes from Brand-X. Similarly, the user's exposure to the advertisement that was targeted using the keyword “tennis,” irrespective of the user's selection of the advertisement, may have also contributed to the user subsequently taking action that constituted a conversion (e.g., purchasing a product from advertiser X). Analysis of user interactions, with an advertiser's advertisements (or other content), that occur prior to selection of the last selected advertisement can enhance an advertiser's ability to understand the advertiser's conversion cycle.

A conversion cycle is a period that begins when a user is presented an advertisement and ends at a time at which the user takes action that constitutes a conversion. A conversion cycle can be measured and/or constrained by time or actions and can span multiple user sessions. User sessions are sets of user interactions that are grouped together for analysis. Each user session includes data representing user interactions that were performed by a particular user and within a session window (i.e., a specified period). The session window can be, for example, a specified period of time (e.g., 1 hour, 1 day, or 1 month) or can be delineated using specified actions. For example, a user search session can include user search queries and subsequent actions that occur over a 1 hour period and/or occur prior to a session ending event (e.g., closing of a search browser).

Analysis of a conversion cycle can enhance an advertiser's ability to understand how its customers interact with advertisements over a conversion cycle. For example, if an advertiser determines that, on average, an amount of time from a user's first exposure to an advertisement to a conversion is 20 days, the advertiser can use this data to infer an amount of time that users spend researching alternative sources prior to converting (i.e., taking actions that constitute a conversion). Similarly, if an advertiser determines that many of the users that convert do so after presentation of advertisements that are targeted using a particular keyword, the advertiser may want to increase the amount of money that it spends on advertisements distributed using that keyword and/or increase the quality of advertisements that are targeted using that particular keyword.

Measures of user interactions that facilitate analysis of a conversion cycle are referred to as conversion path performance measures. A conversion path is a set of user interactions by a particular user prior to a conversion by the particular user. Conversion path performance measures specify durations of conversion cycles, numbers of user interactions that occurred during conversion cycles, paths of user interactions that preceded a conversion, numbers of particular user interactions that occurred preceding conversions, as well as other measures of user interaction that occurred during conversion cycles, as described in more detail below.

The content management system 110 includes a performance analysis apparatus 120 that determines conversion path performance measures that specify measures of user interactions with content items during conversion cycles. The performance analysis apparatus 120 tracks, for each advertiser, user interactions with advertisements that are provided by the advertiser, determines (i.e., computes) one or more conversion path performance measures, and provides data that cause presentation of a performance report specifying at least one of the conversion path performance measures. Using the performance report, the advertiser can analyze its conversion cycle, and learn how each of its keywords cause presentation of advertisements that facilitate conversions, irrespective of whether the keywords caused presentation of the last selected advertisement. In turn, the advertiser can adjust campaign parameters that control distribution of its advertisements based on the performance report.

Configuration options can be offered to reduce bias in performance reports. Without configuration options, some performance reports can be biased, such as towards short conversion paths. For example, a performance report can be biased towards short conversion paths if data used as a basis for the report includes a percentage of partial conversion paths which is higher than a threshold percentage. A partial conversion path is a conversion path in which some but not all user interaction data for a user is associated with a conversion. A partial conversion path can be included in a report if, for example, the report is generated using a reporting period which is less then the length of a typical conversion cycle for the advertiser who requested the report.

A reporting period determines the maximum length (in days) of a reported conversion cycle because additional data outside of the reporting period is not used to generate the report. A performance report can be based on a reporting period (i.e., lookback window), such that user interactions prior to the reporting period are not considered part of the conversion cycle when generating the report. Such a reporting period is referred to as a “lookback window”. For example, when generating a report with a lookback window of thirty days, available user interaction data representing user actions that occurred between July 1 and July 31 of a given year would be available for a conversion that occurred on July 31 of that year.

If a default lookback window (e.g., thirty days) is used, the performance report can be biased towards short conversion paths if the typical conversion cycle length for a product associated with the report is greater than the default lookback window. For instance, in the example above, a typical conversion cycle for “Brand-X” tennis shoes may be relatively short (e.g., thirty days) as compared to a conversion cycle for a more expensive product, such as a new car. A new car may have a much longer conversion cycle (e.g., ninety days).

Different advertisers or different products for an advertiser can have different associated conversion cycle lengths. For example, an advertiser that sells low cost (e.g., less than $100) products may specify a lookback window of 30 days, while an advertiser that sells more expensive products (e.g., at least $1,000) may specify a lookback window of 90 days.

In some implementations, an advertiser 108 can specify a lookback window to use when requesting a performance report, such as by entering a number of days or by selecting a lookback window from a list of specific lookback windows (e.g., thirty days, sixty days, or ninety days). Allowing an advertiser to configure the lookback window of their performance reports enables the advertiser to choose a lookback window that corresponds to their own conversion cycles. Allowing lookback window configuration also enables advertisers to experiment with different lookback windows, which can result in discovering ways to improve conversion rates.

Other factors can contribute to reporting on partial conversion paths. For example, as mentioned above, user interaction data used as a basis for a report can be associated with unique identifiers that each represents a user device with which the user interactions were performed. As described above, a unique identifier can be stored as a cookie. Cookies can be deleted from user devices, such as by a user deleting cookies, a browser deleting cookies (e.g., upon browser exit, based on a browser preference setting), or some other software (e.g., anti-spyware software) deleting cookies.

If cookies are deleted from a user device, a new cookie will be set on the user's device when the user visits a web page (e.g., the search system 112). The new cookie may be used to store a new quasi-unique identifier, and thus subsequent user interaction data that occurs on the user device may be associated with a different identifier. Therefore, because each user identifier is considered to represent a different user, the user interaction data associated with the deleted cookies are identified as being associated with a different user than the user interaction data that is associated with the new cookies.

For instance, in the example above, assume that the user deletes cookies after the first search query for “tennis” is performed and that the second search query for “Brand-X” occurs after the cookies are deleted. In this example, performance measures computed based on the user interaction data for the user can show a bias. For example, a path length measure can be computed as one, rather than two, since the advertisement selection resulting from the first search query is not considered part of the same conversion cycle as the advertisement selection resulting from the second search query, since the two user interactions do not appear to have been performed by the same user.

A unique identifier that has a recent initialization time indicates that the unique identifier may have been recently reinitialized on the user device that the unique identifier represents. Accordingly, user interaction data associated with the relatively new unique identifier may represent only a partial conversion path. To reduce bias caused from partial conversion paths, an advertiser can also specify a minimum unique identifier age. The minimum unique identifier age specifies that interaction data are only eligible to be used to compute measures of user interactions if the interaction data are associated with unique identifiers that are at least the minimum age. User interactions that are associated with unique identifiers that are not at least the minimum age are excluded from being used to compute measures of user interactions. For example, the user interaction data used to generate the report are user interaction data that are associated with (i.e., indexed according to, stored in a cookie with, and/or stored with a reference to) unique identifiers that have initialization times that are prior to a specified period (e.g., thirty days, sixty days, ninety days) before the conversions.

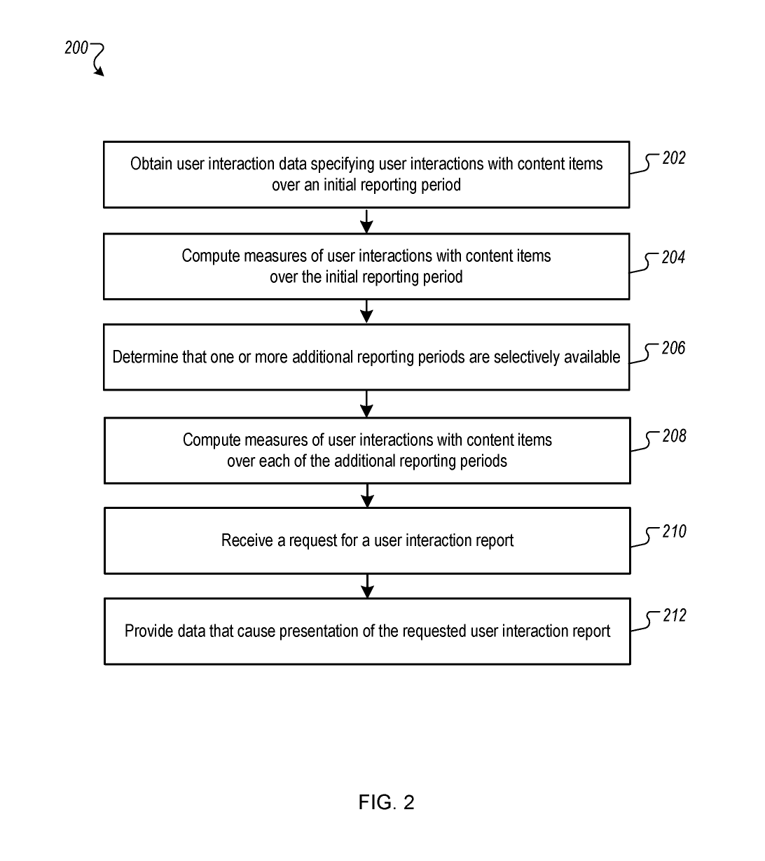

FIG. 2 is a flow chart of an example process 200 for presenting a user interaction report. The process 200 is a process by which a user interaction report can be presented, where the user interaction report is based on measures of user interaction data over one or more reporting periods (i.e., lookback windows).

The process 200 is described below with reference to advertising campaigns that control distribution of advertisements in an online environment. However, the process 200 can also be used with other content distribution campaigns that control distribution of other content (e.g., video, audio, or other content).

The process 200 can be implemented, for example, by the performance analysis apparatus 120 and/or the content management system 110 of FIG. 1. In some implementations, the performance analysis apparatus 120 is a data processing apparatus that includes one or more processors that are configured to perform actions of the process 200. In other implementations, a computer readable medium can include instructions that when executed by a computer cause the computer to perform actions of the process 200.

User interaction data specifying user interactions with content items for an initial reporting period are obtained (202). For example, user interaction data that are associated with one or more conversions and represent user interactions that occurred over the initial reporting period can be obtained. A user conversion is a specified user action that satisfies a conversion condition and the initial reporting period for each conversion is a period preceding each user conversion over which user interaction data is available. For example, the initial reporting period can be specified as a 120 day period preceding a conversion. Thus, the user interaction data for each conversion can represent user interactions that occurred up to 120 days prior to the conversion.

Measures of user interactions with content items over the initial reporting period are computed (204). The measures of user interaction can be computed using user interaction data for the initial reporting period. For example, if the initial reporting period is specified to be 120 days, user interaction data for each conversion being analyzed can be data representing user interactions by the user that performed the conversion and that occurred within 120 days of the conversion (i.e., data within the initial reporting period). The user interaction data that are within the initial reporting period can be user interaction data that are associated with timestamps that specify times that are within the initial reporting period.

The measures of user interactions can specify quantities of interactions that occurred with content items prior to the conversions. For example, the measures of user interactions for a set of conversions can specify an average quantity of content item presentations to converting users (i.e., users that performed the conversions) prior to the conversions, an average quantity of content item selections (i.e., clicks) by the converting users prior to the conversions, an average quantity of total user interactions (i.e., presentations and/or selections) with the converting users prior to the conversions, an average time from an initial interaction with the converting users to conversion by the converting users, and other measures of user interactions prior to the conversions. Other statistical measures (e.g., standard deviation, minimum, maximum, and/or median) of the user interactions can also be computed.

The measures of user interactions can be computed on a per-advertiser basis or a per-advertisement basis. For example, the measures of user interactions can be computed using user interaction data representing user interactions with all content items that are distributed for an advertiser. The measures of user interactions can also be computed on a per-advertising characteristic basis. For example, the measures of user interactions can be computed on a per-targeting keyword basis, where the measures of user interactions for each targeting keyword are computed based on user interactions with content items for which the targeting keyword caused presentation of the content item. For example, if a user submits a search query “football,” a content item (e.g., advertisement) that is targeted using the targeting keyword “football” may be selected for presentation to the user. In this example, the presentation of the content item and/or subsequent user interactions with the content item can be used to compute the measures of user interactions for the targeting keyword football.

In some implementations, the measures of user interactions can be computed in response to each user request for the measures. In other implementations, the measures of user interactions for the initial reporting period can be pre-computed (i.e., prior to a request for the measures) to increase the speed with which the measures of user interactions can be provided in response to a request. For example, as the amount of user interaction data (and/or a number of requests for measures increases) it can become more difficult to compute and provide the measures of user interactions on demand. By pre-computing the measures of user interactions, the measures of user interactions can continue to be provided in near real-time as dataset sizes and request volumes increase.

The process determines that one or more additional reporting periods are selectively available (206). For example, the initial reporting period can be one reporting period out of a set of two or more reporting periods that have been identified as reporting periods for which measures of user interactions can be requested, computed, and/or provided. In some implementations, the initial reporting period represents a maximum reporting period (i.e., a maximum lookback window) over which the measures of user interactions are available, and each of the additional reporting periods are periods that are shorter than the initial reporting period. For example, if the initial reporting period is selected to be a 120 day period preceding each conversion, the additional reporting periods can include reporting periods of 90 days, 60 days, and/or 30 days. In this example, an advertiser can be presented an option to select one or more of the reporting periods (i.e., initial reporting period and/or additional reporting periods) as the period(s) for which measures of user interactions are to be provided.

Measures of user interactions with content items over each of the additional reporting periods are computed (208). For example, measures similar to those computed for the initial reporting period can be computed for the additional reporting periods. As described above, the measures of user interactions can be pre-computed for each of the additional reporting periods or the measures of user interactions can be computed in response to a request for the measures of user interactions (i.e., a request for the user interaction report).

A request for a user interaction report is received (210). For example, a request for a user interaction report that specifies measures of user interactions with content items over at least one reporting period can be received. A request for a user interaction report can be received, for example, in response to a user selecting a report request element (e.g., a user interface control, such as a link, menu, or button) on a user interface. The user interface can include a report period element that enables an advertiser to specify a reporting period for the user interaction report.

Data that cause presentation of the requested user interaction report are provided (212). For example, the requested user interaction report can be presented on a user interface when the data that cause presentation are provided to the user device and received by the user device. As another example, data can be provided that cause presentation of a user interaction report that specifies measures of user interaction for one or more conversions over two or more reporting periods. The specified measures of user interaction can be computed, for example, using user interaction data for user interactions that are associated with a timestamp that is within at least one of the two or more reporting periods. The specified measures of user interaction for one of the reporting periods can be presented at a first presentation location that is adjacent to a second presentation location at which the specified measures of user interaction for a second reporting period.

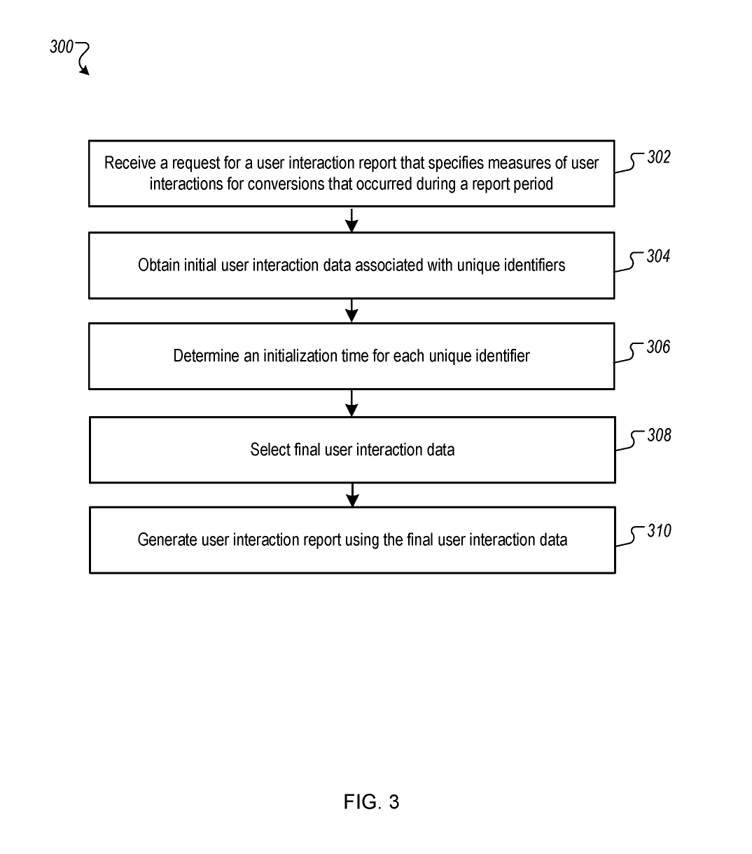

In some implementations, the user interaction data that are used to compute the measures of user interactions can include user interaction data representing user interactions by each user that performed a conversion irrespective of when the user identifier for the user was assigned to the user. In other implementations, the measures of user interactions can be computed using user interaction data that is associated with a user identifier that is at least a minimum specified age (i.e., a user identifier that was associated with the user device at a time that precedes the conversion by a minimum amount). As described in more detail with reference to FIG. 3, the age of a user identifier can be determined using an initialization time for the user identifier, such that a comparison of the time at which the conversion occurred and the initialization time of the user identifier associated with the conversion can be used to determine whether the conversion and the user interaction data for the conversion will be used to compute the measures of user interactions for a user interaction report.

FIG. 3 is a flow chart of an example process 300 for generating a user interaction report. The process 300 is a process by which a user interaction report can be generated based on user interaction data associated with unique identifiers having initialization times that at least a minimum specified age.

The process 300 is described below with reference to advertising campaigns that control distribution of advertisements in an online environment. However, the process 300 can also be used with other content distribution campaigns that control distribution of other content (e.g., video, audio, or other content).

The process 300 can be implemented, for example, by the performance analysis apparatus 120 and/or the content management system 110 of FIG. 1. In some implementations, the performance analysis apparatus 120 is a data processing apparatus that includes one or more processors that are configured to perform actions of the process 300. In other implementations, a computer readable medium can include instructions that when executed by a computer cause the computer to perform actions of the process 300.

A request for a user interaction report that specifies measures of user interactions with content items over a reporting period is received (302). For example, a request can be received for a conversion path report that specifies measures of user interactions over conversion paths for conversions that occurred within a previous 30 days. A conversion path is a set of user interactions with one or more content items and an action that constitutes a conversion. User interactions can be, for example, one or more presentations of the content items to the user and zero or more selections of the content items by the user.

As described above, the reporting period can be specified by a user (e.g., advertiser). In some implementations the reporting period can be specified base on selection of a report period from a filter element displayed on a user interface, or based on a default reporting period (e.g., 30 days) that has been set for user interaction reports. The request for the user interaction report can be received, for example, from a user device or from another device, such as the advertising management system 110 of FIG. 1.

Initial user interaction data associated with unique identifiers are obtained (304). For example, initial user interaction data can be user interaction data that are associated with the conversions that occurred during the reporting period. Initial interaction data can also be associated with a conversion, for example, by being indexed in a data store according to a conversion identifier for the conversion and/or stored at a memory location that is assigned to the conversion. The initial user interaction data that are associated with the conversion can also be, for example, user interaction data that are associated with a same user identifier as the conversion, where the user identifier represents a user device that was used to perform the user interactions that preceded the conversion. For example, the user identifier representing the user device that is used to interact with content items and perform an action that constitutes a conversion can be stored with, and/or appended to, data representing the user interactions performed with the user device. Thus, the initial user interaction data can be obtained by obtaining, for each conversion, user interaction data representing each user interaction that occurred during the conversion cycle for the conversion and is associated with a same user identifier as the conversion.

In some implementations, a unique identifier can be a cookie. The cookie can represent a unique pair of components including a user device and a browser. The cookie can have associated data, which can be stored in association with the cookie as one or more name-value pairs. In other implementations, other event tracking identifiers can be used.

An initialization time is determined for each unique identifier (306). For example, in implementations where the user identifier is a cookie, an initialization time can be a value specified by the contents of a cookie, with the initialization time being a time at which the cookie was set on the a user device. The initialization time can be set, for example, to the system time of a server device or the user device. For example, at the time of sending the cookie to the user device, the server can set the initialization time of the cookie equal to the server system time. The initialization time can be, for example, specified using a name-value pair associated with the cookie.

Final user interaction data are selected (308). In some implementations, final user interaction data are selected from the initial interaction data. The initial interaction data that are selected as final interaction data can be, for example, the initial interaction data that are associated with unique identifiers having at least a minimum age (e.g., a cookie age). The age of a unique identifier is an amount of time between an initialization time for the unique identifier and a time at which a conversion that is associated with the unique identifier occurred. For example, assume that a particular cookie is set on a user device at 11:00 am on Jul. 21, 2010. Further assume that the particular cookie is associated with a conversion that occurs on Jul. 31, 2010 at 11:00 am and that the minimum age is 5 days. In this example, user interaction data that is associated with the particular cookie will be used to compute measures of user interactions for the conversion because the age of the cookie (i.e., cookie age) is 10 days, which is greater than the minimum age of 5 days.

In some implementations, a default minimum age can be used to select user interaction data that will be used to compute measures of user interactions for the conversions. For example, the default minimum age can be a specified absolute age (e.g., 15 days). Alternatively, the default minimum age can depend on the reporting period for a requested user interaction report. For example, the default minimum age can be set to two-thirds of the length of the reporting period, such that the minimum age for a 30 day reporting period will be 20 days. In this example, user interaction data that are associated with user identifiers having initialization times that are at least 20 days prior to the conversion will be selected as final user interaction data.

In other implementations, the minimum age can be specified by the user (e.g., advertiser) that is requesting the user interaction report. For example, the request for the user interaction report can include data specifying the minimum age for the requested report. Alternatively, the minimum age for all reports that are generated for a particular user can be specified in a “report options” user interface, or a similar user interface.

A user interaction report is generated using the final user interaction data (310). The user interaction report can be, for example, a conversion path report that specifies measures of user interactions over a conversion path. The user interaction report can include measures of user interactions similar to those described above. The user interaction report can be presented, for example, by use of a user interface. In some implementations, the user interaction report can be presented in a user interface which includes a dual-report element that upon selection causes presentation of the user interaction report using the final user interaction data and further causes presentation of another user interaction report using the initial user interaction data.

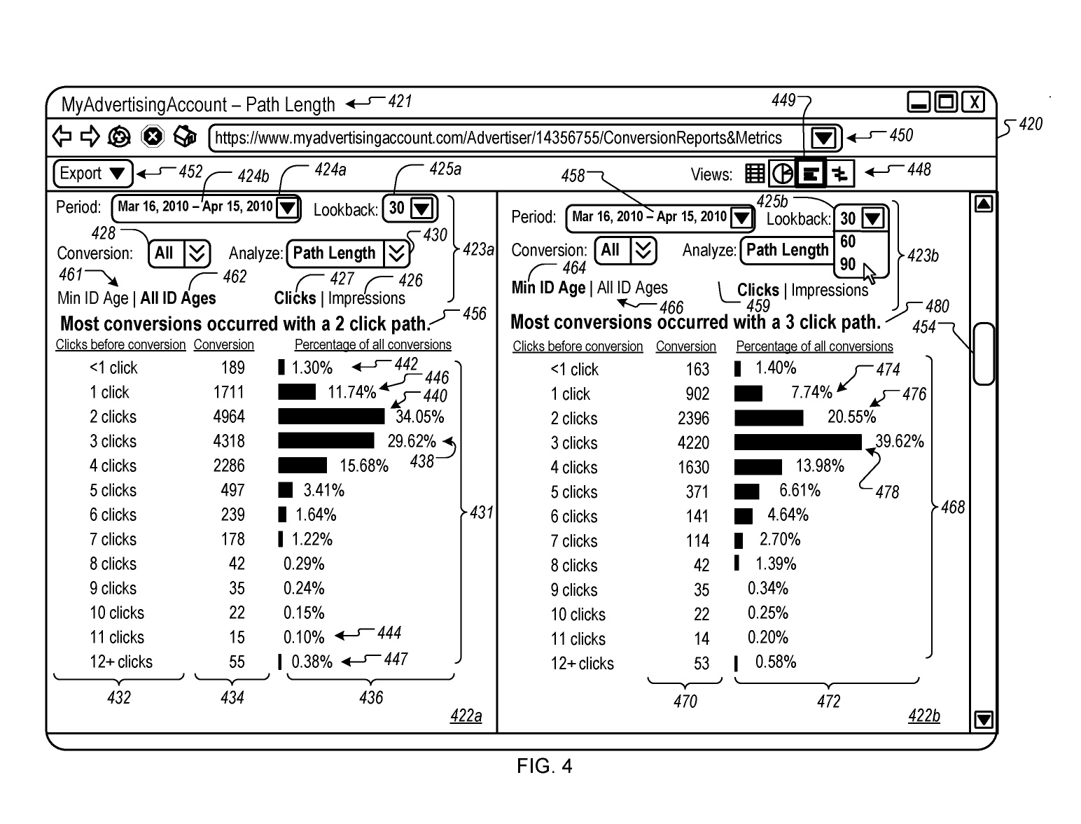

FIG. 4 is a screen shot of an example user interface 420 for providing a user interaction report. For example, an advertiser 108 (e.g., the advertiser of Brand X shoes) can use the user interface 420 to display and review information for advertisement conversion measures and reports associated with conversion path lengths. In some implementations, the user interface 420 is displayed in a web browser by an advertiser 108 based on information provided over the network 102. In some implementations, the information provided in the user interface 420 includes conversion information (e.g., path length measures for conversions and associated data) provided by the content management system 110 and/or the performance analysis apparatus 120.

The user interface 420 includes a header 421, a first report area 422a, and a second report area 422b. The header 421 (e.g., “MyAdvertisingAccount—Path length”) identifies the information in the user interface 420 as relating to conversion path length information associated with an advertising account. The first report area 422a displays advertisement conversion information, specifically displaying and summarizing conversion path length information for a specific time period based on settings 423a established by the user (e.g., the advertiser 108 displaying the user interface 420). The second report area 422a allows presentation of conversion information using settings 423b that can be different than the setting 423a (e.g., a different reporting period and/or a different minimum age). Thus, the report enables presentation of conversion information in a different view and adjacent with the first report area 422a.

The settings 423a include various settings for controlling the type of path length report that is displayed in the first report area 422a. For example, the settings 423a includes a date range selection control 424a. The date range selection control 424a enables the user (e.g., advertiser) to specify a conversion period (e.g., a date range within which conversions occurred) for the assisted conversion measures that are presented in the first report area 422a. The date range specified in the date range selection control 424a can be used to select conversions for which the path length measures presented in the first report area 422a are computed. In some implementations, the date range can be used to select user interaction data that is associated with conversions that occurred within the specified reporting period, user interaction data that is associated with conversion paths (or cycles) where the entire conversion path occurred during the specified reporting period, or user interaction data that is associated with conversion paths where any portion of the conversion path occurred during the specified reporting period.

As shown, a current time period selection 424b that has been selected using the date range selection control 424a is the month-long period from Mar. 16 to Apr. 15, 2010. In some implementations, this time period can correspond to any time duration selected by the advertiser. For example, the user can select a time period as short as a few hours up to a time period of several days or weeks, such as a 30-day duration, and years. Some advertisers may select a longer date range than others because, in general, while some advertisement conversions can occur rapidly, even within a few seconds, others can take several days, weeks, or longer. As a result, path lengths that originate, for example, from the first ad impression that is presented the user, can span several hours or days before a conversion occurs.

In some implementations, when the user selects the date range selection control 424a, a calendar interface (not shown) can appear. For example, the user can identify dates in the current selection 424b by clicking on individual cells on a calendar display, such as cells for Mar. 16 and Apr. 15, 2010. In some implementations, the date range selection control 424a can provide additional controls for specifying time ranges on specific dates. An example range using date and time, for example, can be noon on Mar. 16, 2010 to 4 PM on Mar. 17, 2010. In some implementations, various controls (e.g., sliders, etc.) can be used to allow the user to specify dates and times, without having to type in values explicitly, for example.

In some implementations, an advertiser can use a lookback control 425a to configure a lookback window for the conversion path in the report shown in the first report area 422a. The value of the lookback control 425a can define a time interval preceding a conversion during which user interactions are considered to assist the conversion, such that user interaction data for these conversions are used to compute the conversion path measures that are presented in the report. For example, if the value of the lookback control 425a is thirty, as shown, user interactions occurring between Mar. 1, 2010 and Mar. 31, 2010 that are associated with a conversion occurring on Mar. 31, 2010 can be used as user interaction data for computing the conversion path report. In some implementations, a user can select a lookback window value from a predefined set of lookback window values in the lookback control 425a. In some implementations, a user can enter (e.g., type) a lookback window value into the lookback control 425a. The lookback control 425a can be configured to accept up to and including a maximum value (e.g., ninety).

The lookback window can be greater than the conversion period, less than the conversion period, or the same as the conversion period. For example, if the conversion period is set to a previous 60 days, the report can be generated for conversions that happened in the previous 60 days. In this example, when the lookback window is set of 30 days, the user interaction data that is used to generate the report is the user interaction data, for each conversion, that occurred within the 30 days that preceded the conversion. If the lookback window is set to 90 days, then the user interaction data that is used to generate the report will be the user interaction data that occurred within the 90 days that preceded each conversion.

In some implementations, measures of user interactions and/or user interaction reports can be pre-computed for some or all of the selectable lookback windows (e.g., the lookback window values displayed in the lookback control 425a). For example, pre-computed measures of user interactions can be computed for each conversion and sets of conversions for thirty, sixty, and ninety day lookback windows. Pre-computation can include creating conversion paths for each stored conversion event in a set of user interaction data. A pre-computed user interaction report for a thirty day lookback window, for example, can include conversion paths which include all events up to thirty days preceding the conversions that occurred during the conversion period.

If a user selects a lookback window value associated with pre-computed measures of user interactions, the report shown can be generated based on the pre-computed measures. If the lookback control 425a allows entry of a value other than a selectable value, and if the user enters a value other than a selectable value into the lookback control 425a, conversion paths can be generated in response to a request for a user interaction report for the selected lookback window. In turn, the user interaction report can be generated and displayed. When the user interaction report is generated in response to the request for a new lookback window, the time required to present the report may be greater than that required to present pre-computed user interaction reports.

As discussed above, selecting a longer lookback window can reduce bias caused by partial conversion paths. A user (e.g., advertiser) can select various lookback windows and can analyze the effect on displayed reports. An advertiser can also compare reports having different lookback windows. For example, an advertiser can select a thirty day lookback window using the lookback control 425a for a report presented in the first report area 422a and can select a ninety day lookback window using a lookback control 425b for a report presented in the second report area 422b.

The settings 423a includes a path length type control 426 which can include, for example, active links or another user interface elements that upon selection cause submission of a request for one or more different types of path length reports. In the present example, the path length type control 426 can cause presentation of a click path length report or an impressions path length report. For example, user selection of the “clicks” active link 427 can cause submission of a request for a click path length report, while selection of the “impressions” active link 426 can cause submission of a request for an impression path length report. In response to the submission, data that cause presentation of the selected report can be provided to the user device. As shown in FIG. 4, the current selection 427 is set to display a click path length report and a click path length report is presented in the first report area 422a.

The settings 423a includes a conversion type selection control 428 that enables the user to specify one or more types of conversions for which the path length report includes related information. In some implementations, the conversion type selection control 428 can be a drop down menu having user selectable options. In other implementations, the conversion type selection control 428 can be a hypertext link or another user interface control element (e.g., a text box, check box, or radio button). In the example shown, the conversion type selection control 428 indicates that the path length report includes information for “all” types of conversions is presented in the first report area 422a.

Path length reports can be generated for each of many different types of conversions. In some implementations, each of the following user actions can be identified as a different conversion type: signing up for a mailing list, making a purchase, creating a user profile, making a reservation, requesting presentation of a video, requesting presentation of audio, downloading one or more files, installing one or more programs on the user device, or providing specified information, and a separate path length report can be generated for each of these different conversion types. In some implementations, a report for each conversion type can be requested and/or presented within a same user interface display.

Each advertiser can specify its own set of conversion types and the user actions that constitute a conversion for each conversion type. For example, an on-line gaming company can identify three types of conversions. The first conversion type can be identified as an information conversion that is completed when a mailing address (physical or electronic) is received from a user. The second conversion type can be identified as a download conversion that is completed when a user downloads and/or installs a trial version of an on-line game. The third conversion type can be identified as a purchase conversion that is completed when a user purchases an on-line game. In this example, the conversion type selection control 428 enables allows the user (i.e., the advertiser) to request presentation of an path length report that specifies path length measures for purchase conversions and/or an path length report that specifies path length measures for other types of conversions (e.g., information conversions or download conversions).

An analysis type selection control 430 allows the user to specify the type of information displayed on the screen. The current setting for the analysis type selection control 430 is “Path length”, which agrees with the “Path length” annotations indicated in the header 421. As an example of how to change the type of information displayed in the user interface 420, the user can select a different setting (e.g., “Time Lag”) from the analysis type selection control 430. In response to the change, information related to the different setting (e.g., time lags) is displayed, and the header 421 is updated to indicate the new selection (e.g., “Time Lag”).

A table portion 431 of the first report area 422a provides detailed path length information. For example, the table portion 431 includes data values and display areas related to conversion path lengths. The table portion 431, as depicted using the current settings for various user controls and settings, includes rows of information arranged in three columns. A clicks column 432 (e.g., “Clicks before conversion”) identifies ranges of path lengths corresponding to conversions. For instance, the path lengths listed in the clicks column 432 specify numbers of clicks that occur before conversion (i.e., click path lengths) ranging from less than 1 click up to 12 or more clicks.

A conversion counts column 434 identifies the number of conversions that occurred for each of the path lengths identified by the clicks column 432. A conversion percentages column 436 identifies the overall percentage (e.g., relative to 100% of the conversions) that each of the conversion counts represents, on a row-by-row basis in the table portion 431.

For example, a row 438 in the table portion 431 identifies 4318 as the number of conversions that occurred with three clicks. The value 4,318 represents 29.62% of the overall total of conversions, as indicated by the percentage displayed in the row 438.

In another example, as indicated in a row 440, a total of 4,964 conversions occurred with two clicks. This value represents 34.05% of the conversions that occurred during the month-long period from Mar. 16 to Apr. 15, 2010.

In another example row 442, the value of 189 conversions, or 1.3%, occurred in less than one click. In other example rows 444, 446, and 447, a total of 15 conversions occurred with 11 clicks, a total of 1,711 conversions occurred with 1 click, and a total of 55 conversions occurred with 12 or more clicks.

The user interface 420 includes a display type selection control 448 that can be used, for example, to select one or more types of views for displaying information in the conversion percentages column 436, or elsewhere in the user interface. For example, the view selection 449 that is currently selected is the histogram view option, as indicated by a histogram icon. As a result, in addition to the percentages displayed in the conversion percentages column 436, path length measures are also presented in a histogram (i.e., in bar graph form), and a length of each group (or bar) is proportional to the percentage of conversions that are represented by a particular row (e.g., rows 438, 440, 441, etc.). The largest group (or longest bar) in this case appears in the row 440, representing the highest number (e.g., 4,964) of the conversions for any one number of clicks in column 432.

The user interface 420 includes other controls and areas. For example, an address bar 450 can identify the address (e.g., URL) that is associated with (e.g., identifies a network location for) the data that cause presentation of the current display of the user's browser, in this case path length information for an advertising account. An export control 452 can provide the user with options for exporting information from the user interface 420, primarily the information included in the table 431 and the identification of any user settings used to generate the data. The export control 452 can also be used to export user interaction data and/or data that may have been computed as described herein, but has not been presented. A scroll bar 454 is provided in some implementations to allow the user to scroll to other parts of the user interface 420, for example, when the entries in the table 431 exceed the viewport of the first report area 422a.

The first report area 422a includes a summary 456 (e.g., “Most conversions occurred with a 2 click path”) which can be used to direct the user's attention to specific information on the first report area 422a. For example, the summary 456 in this case points out that the highest number of conversions corresponds to the information displayed in the row 440.

The settings 423a include a minimum identifier age filter control 461. A user can use the “Min ID Age” control 461 to toggle between a user interaction report that uses all user interaction data during the lookback window and another user interaction report that uses user interaction data that is associated with a user identifier that is at least a minimum age. The current selection 462 is set to an “all ID ages” setting. Therefore, the report shown in the first report area 422a can be based on all available user interaction data representing user interactions with content items over the selected lookback window, including user interaction data associated with recently initialized unique identifiers. As described above, user interaction data associated with recently initialized unique identifiers can be an indication that the user interaction data is associated with a partial conversion path, such as due to deletion and subsequent reinitialization of cookies.

As indicated by a current selection 464 of a “Min ID Age” control 466 included in the settings 423b, the report displayed in the second report area 422b is based on user interaction data that is associated with a “min ID age.” That is, the report displayed in the second report area 422b is based on user interaction data which are associated with unique identifiers that have associated initialization times specifying times that each precede an associated conversion by a minimum amount of time For the sake of the discussion below, the user interaction data used as the basis for the report in the second report area 422b is referred to as “cleaned” user interaction data the user interaction data used as the basis for the report in the first report area 422a is referred to as “uncleaned” user interaction data.

A table portion 468 of the second report area 422b provides detailed path length information based on the settings 423b. Since the occurrence of partial conversion paths is reduced in the cleaned user interaction data, the cleaned user interaction data generally has fewer conversions than the uncleaned user interaction data. For example, the total of the values in a conversion counts column 470 is less than the total of the values in the conversion counts column 434.

Additionally, the distribution of conversion percentages in a conversion percentages column 472 is different than the distribution of conversion percentages in the conversion percentages column 436. For example, as indicated by a row 474, the number of conversions in the cleaned user interaction data that occurred with one click (e.g., 902) is less than the conversions that occurred with one click in the uncleaned user interaction data (e.g., 1,711, as indicated by row 446). Similarly, as indicated by a row 476, the number of conversions in the cleaned user interaction data that occurred with two clicks (e.g., 2,396) is less than the conversions that occurred with two clicks in the uncleaned user interaction data (e.g., 4,964, as indicated by row 440). A summary 480 points out that the highest number of conversions for the cleaned user interaction data corresponds to the information displayed in the row 478.

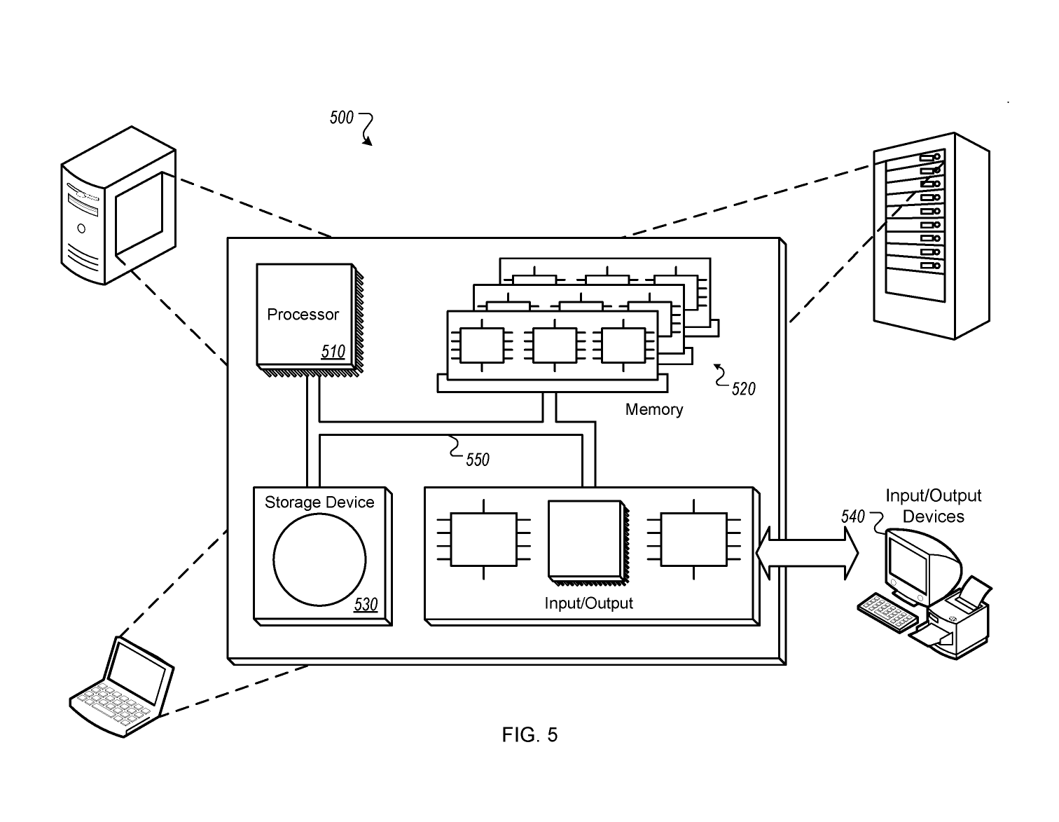

FIG. 5 is a block diagram of an example computer system 500 that can be used to provide user interaction reports. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

The performance analysis apparatus 120 and/or content management system 110 can be realized by instructions that upon execution cause one or more processing devices to carry out the processes and functions described above. Such instructions can comprise, for example, interpreted instructions, such as script instructions, e.g., ECMAScript instructions, or executable code, or other instructions stored in a computer readable medium. The bid recommendation subsystem 120 and/or content management system 110 can be distributively implemented over a network, such as a server farm, or can be implemented in a single computer device.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system, comprising:
a historical data store storing data obtained from cookies that have been placed on various client devices;
an analysis apparatus that interacts with the historical data store and reduces measurement bias with a filter that filters out data obtained from cookies that are less than a threshold age through performance of operations including:
identifying, from contents of a given cookie, an initialization time when the given cookie was placed on a given client device by a server;
determining, based on the initialization time, that the cookie has an age that is less than the threshold age; and
filtering data obtained from the given cookie from a final set of data that is used to generate measurements based on the age of the cookie being less than the threshold age.

2. The system of claim 1, wherein the analysis apparatus performs operations comprising:
receiving a request for a measurement generated using the data obtained from the cookies;
generating the measurement using the data included in the final set of data following the filtering; and
providing a visual representation of the measurement in a user interface.

3. The system of claim 2, wherein providing the user interface comprises providing a user interface that includes a control for varying the threshold age.

4. The system of claim 2, wherein generating the measurement comprises generating a measurement of interactions that occurred at client devices prior to a specified action.

5. The system of claim 1, wherein the analysis apparatus performs operations comprising:
providing a user interface that includes a first measurement report generated with the data included in the final set of data following the filtering; and
providing, within the user interface, a second measurement report generated with the data obtained from the cookies prior to the filtering.

6. The system of claim 1, wherein the age of the cookie is determined relative to a specified action being performed by a user.

7. The system of claim 6, wherein the specified action is stored in the historical data store with a reference to a corresponding cookie of the client device at which the specified action occurred.

8. A method performed by one or more processors of an analysis apparatus, comprising:
obtaining, by the one or more processors and from a historical data store storing data obtained from cookies that have been placed on various client devices, a set of the data obtained from the cookies;
identifying, by the one or more processors and from contents of a given cookie, an initialization time when the given cookie was placed on a given client device by a server;
determining, by the one or more processors and based on the initialization time, that the cookie has an age that is less than the threshold age; and
filtering, by the one or more processors, data obtained from the given cookie from inclusion in a final set of data that is used to generate measurements based on the age of the cookie being less than the threshold age.

9. The method of claim 8, comprising:
receiving a request for a measurement generated using the data obtained from the cookies;
generating the measurement using the data included in the final set of data following the filtering; and
providing a visual representation of the measurement in a user interface.

10. The method of claim 9, wherein providing the user interface comprises providing a user interface that includes a control for varying the threshold age.

11. The method of claim 9, wherein generating the measurement comprises generating a measurement of interactions that occurred at client devices prior to a specified action.

12. The method of claim 8, comprising:
providing a user interface that includes a first measurement report generated with the data included in the final set of data following the filtering; and
providing, within the user interface, a second measurement report generated with the data obtained from the cookies prior to the filtering.

13. The method of claim 8, wherein the age of the cookie is determined relative to a specified action being performed by a user.

14. The method of claim 13, wherein the specified action is stored in the historical data store with a reference to a corresponding cookie of the client device at which the specified action occurred.

15. A non-transitory computer storage medium encoded with a computer program, the program comprising instructions that when executed by one or more data processing apparatus cause the one or more data processing apparatus to perform operations comprising:
obtaining, by the one or more processors and from a historical data store storing data obtained from cookies that have been placed on various client devices, a set of the data obtained from the cookies;
identifying, by the one or more processors and from contents of a given cookie, an initialization time when the given cookie was placed on a given client device by a server;
determining, by the one or more processors and based on the initialization time, that the cookie has an age that is less than the threshold age; and
filtering, by the one or more processors, data obtained from the given cookie from inclusion in a final set of data that is used to generate measurements based on the age of the cookie being less than the threshold age.

16. The non-transitory computer storage medium of claim 15, wherein the instructions cause the one or more data processing apparatus to perform operations comprising:
receiving a request for a measurement generated using the data obtained from the cookies;
generating the measurement using the data included in the final set of data following the filtering; and
providing a visual representation of the measurement in a user interface.

17. The non-transitory computer storage medium of claim 16, wherein providing the user interface comprises providing a user interface that includes a control for varying the threshold age.

18. The non-transitory computer storage medium of claim 16, wherein generating the measurement comprises generating a measurement of interactions that occurred at client devices prior to a specified action.

19. The non-transitory computer storage medium of claim 15, comprising:
providing a user interface that includes a first measurement report generated with the data included in the final set of data following the filtering; and
providing, within the user interface, a second measurement report generated with the data obtained from the cookies prior to the filtering.

20. The non-transitory computer storage medium of claim 15, wherein the age of the cookie is determined relative to a specified action being performed by a user.
